(19) United States
(12) Patent Application Publication
(10) Pub. No.: US 2025/0345766 A1
(43) Pub. Date: Nov. 13, 2025

(54) APPARATUS AND METHOD FOR CARBON DIOXIDE CONVERSION

(71) Applicant: UNIVERSITEIT ANTWERPEN, Antwerpen (BE)

(72) Inventors: Annemie BOGAERTS, Wommelgem (BE); Claudia VERHEYEN, Antwerpen (BE)

(21) Appl. No.: 18/871,102

(22) PCT Filed: Jun. 5, 2023
(86) PCT No.: PCT/EP2023/064918

§ 371 Date: Dec. 2, 2024

(30) Foreign Application Priority Data
Jun. 8, 2022 (EP) 22177872.3

(51) Int. Cl. B01J 12/00; B01F 23/10; B01F 35/213; B01F 35/221; B01F 101/00; B01J 4/00; B01J 19/00; C01B 32/40

(52) U.S. Cl. CPC B01J 12/005; B01F 23/19; B01F 35/213; B01F 35/2211; B01F 35/2215; B01J 4/008; B01J 19/0006; C01B 32/40; B01F 2101/2204; B01F 2215/0409; B01F 2215/044; B01F 2215/0477; B01J 2204/002; B01J 2219/00186

(57) ABSTRACT

The present disclosure relates to a method for converting carbon dioxide into carbon monoxide comprising: producing atomic oxygen, providing carbon dioxide to be converted, mixing the carbon dioxide with the atomic oxygen within a mixing area such that the atomic oxygen can interact with the carbon dioxide for forming carbon monoxide within the mixing area through a first CO producing reaction: C0₂+0→C0+02, supplying the atomic oxygen into the mixing area at a first supply rate and supplying the carbon dioxide into the mixing area at a second supply rate, defining the first supply rate and the second supply rate such that a ratio between the first supply rate and the second supply rate remains within a pre-defined lower and upper threshold, and extracting carbon monoxide from the mixing area. The present disclosure also relates to an apparatus for converting carbon dioxide into carbon monoxide.

### FIELD OF THE DISCLOSURE

The present disclosure relates to an apparatus and method for converting carbon dioxide into carbon monoxide.

### BACKGROUND

In view of the climate change and the global warming, the conversion of carbon dioxide gasses into valuable products has become a major subject in energy and environmental research.

This strategy of re-utilizing emitted CO2, e.g. coming from recapture or directly from exhausts, and turn it into industrially interesting products, is also known as Carbon Capture and Utilization, CCU.

Many methods for CCU have been developed over the years: electrochemical conversion, solar thermochemical conversion, biochemical conversion, photochemical conversion and many more. Each of these approaches has its benefits, but all of them struggle with different difficulties related to for example catalyst instabilities, the use of rare materials, and cultivation problem. These methods are capable of converting CO2 but often require complex set-ups and thus high investment costs and often have limited scale-up possibilities.

A further approach is a gas conversion approach wherein CO2 is used in gaseous form without the addition of non-gaseous products, such as binding metals, that are needed for conversion.

A known method for CO2 gas conversion is thermal conversion which allows for high conversion rates of carbon dioxide into carbon monoxide. However, a major drawback of thermal conversion is that the conversion happens inefficiently. This is due to the stability of the CO2 molecule and the great amount of energy that is needed to break the double bonds of CO2. Indeed, the conversion reaction, CO2→CO+O, is highly endothermic and has a standard enthalpy ΔH° of 5.5 eV/molecule. To efficiently convert CO2 by thermal conversion, temperatures in the range between 3000° K to 4000° K are required.

Another promising method for CO2 gas conversion is plasma-assisted CO2 conversion. Indeed, plasma technology allows for directly splitting CO2 gas into CO and O through for instance electron-impact dissociation or dissociation following a vibrational ladder-climbing process. Various types of plasma reactors have been proposed for plasma-based CO2 conversion, as for example discussed by Snoeckx and Bogaerts in Chem. Soc. Rev. 2017, 46, 5805.

Although various types of plasma reactors demonstrate promising results for CO2 conversion, in order for the plasma reactor technology to become commercially attractive for large scale applications, further improvements are still desirable. Especially, further research is needed to increase the conversion efficiency while at the same time, keep the energy consumption, also named energy cost, as low as possible.

Hence, there is room for alternative methods and apparatuses for carbon dioxide conversion.

### SUMMARY

It is an object of the present disclosure to provide an alternative cost-effective and simple method and apparatus for conversion of carbon dioxide to carbon monoxide wherein a high conversion efficiency is obtained.

The present invention is defined in the appended independent claims. The dependent claims define advantageous embodiments.

According to a first aspect of the present disclosure, a method for converting carbon dioxide into carbon monoxide is provided.

In one embodiment, the method comprises: providing carbon dioxide to be converted, producing atomic oxygen, mixing the carbon dioxide with the atomic oxygen within a mixing area such that the atomic oxygen can interact with the carbon dioxide for forming carbon monoxide within the mixing area through a first CO producing reaction: CO₂+O→CO+O₂, and evacuating carbon monoxide from the mixing area.

In a further embodiment, a first supply rate (S_{O}) of atomic oxygen and a second supply rate (S_{CO2}) of carbon dioxide is defined such that:

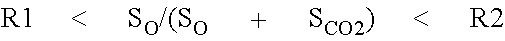

wherein R1 and R2 are respectively a pre-defined lower and a pre-defined upper threshold, wherein R1≥0.1 and R2≤0.9, preferably R1≥0.2 and R2≤0.8, more preferably R1≥0.3 and R2≤0.7.

The method comprises preferably: providing carbon dioxide to be converted, producing atomic oxygen and defining a first supply rate of atomic oxygen and a second supply rate of carbon dioxide such that: R1<S_{O}/(S_{O}+S_{CO2})<R2, with S_{O} and S_{CO2} being respectively the first supply rate and the second supply rate, and wherein R1 and R2 are respectively a pre-defined lower and a pre-defined upper threshold.

The method according to the present disclosure further comprises preferably: mixing the carbon dioxide with the atomic oxygen within a mixing area such that the atomic oxygen can interact with the carbon dioxide for forming carbon monoxide within the mixing area through a first CO producing reaction: CO₂+O→CO+O₂, and supplying the atomic oxygen and carbon dioxide into the mixing area at respectively the first supply rate and the second supply rate, and evacuating carbon monoxide from the mixing area.

The term ‘evacuating’ as used herein refers to the process of “removing”, “extracting” or “diverting” carbon monoxide from the mixing area (M-A), preferably through a gas outlet.

The first supply rate of atomic oxygen has to be construed as a first number of oxygen atoms supplied per unit of time in the mixing area, and the second supply rate of carbon dioxide has to be construed as a second number of carbon dioxide molecules supplied per unit of time in the mixing area.

The carbon dioxide conversion method based on atomic oxygen according to the present disclosure has multiple advantages when compared to prior art carbon dioxide conversion methods.

For instance, the present method does not require any rare materials to be processed and the fact that the conversion process can simply be switched on and off by turning on and off the production of atomic oxygen, makes that the method can advantageously be used in combination with renewable energy.

Advantageously, no external energy is to be supplied to the mixing area. The only energy source needed is for producing the atomic oxygen.

By producing atomic oxygen and bringing the atomic oxygen together with the carbon dioxide to be converted in a mixing area, carbon monoxide can advantageously be produced through the less energy consuming conversion reaction of: CO₂+O→CO+O₂ which has a standard enthalpy ΔH° of 0.3 eV/molecule.

Further, the atomic oxygen will also recombine in the mixing area to molecular oxygen and thereby release energy. Indeed, the oxygen recombination reaction O+O→O₂ is highly exothermic with a standard enthalpy ΔH° of −5.2 eV/molecule, and hence even if starting initially with a mixing area at room temperature, the temperature in the mixing area will quickly, within less than a millisecond, raise to temperatures of hundreds of degree Kelvin and hence allow the above endothermic CO2 conversion reaction to occur.

By controlling the ratio between the atomic oxygen supply rate and the supply rate of the carbon dioxide to be converted, as presently claimed, the occurrence of the oxygen recombination reaction can be controlled and hence the temperature in the mixing area can be controlled. Advantageously, by controlling the atomic oxygen supply rate and the carbon dioxide supply rate, the temperature Tₘ within the mixing chamber can be kept below 2500° K, for example between 800° K≤Tₘ≤2500° K. In this way, the CO2 thermal conversion limit, which is around 3000° K, is not reached and another CO2 conversion reaction of: CO₂+M→CO+O+M wherein the standard enthalpy ΔH° is 5.5 eV/molecule, and with M being any neutral molecule, is suppressed compared to the first CO2 conversion reaction having a much lower standard enthalpy.

According to a second aspect of the present disclosure, an apparatus is provided for converting carbon dioxide into carbon monoxide. The apparatus comprises an atomic oxygen generator for producing atomic oxygen, a mixing area configured for mixing the produced atomic oxygen with carbon dioxide to be converted such that when the apparatus is in operation, atomic oxygen can interact with the carbon dioxide within the mixing area for forming carbon monoxide through a first reaction: CO₂+O→CO+O₂, a carbon dioxide supply configured for supplying carbon dioxide to be converted to the mixing area, a control device configured for controlling a first supply rate of atomic oxygen supplied to the mixing area and controlling a second supply rate of carbon dioxide supplied to the mixing area, and a gas outlet configured for evacuating carbon monoxide from the mixing area.

As the subject matter of the independent apparatus claim allows to implement the method for carbon dioxide conversion as specified by the independent method claim, the advantages discussed above for the method also apply to the apparatus.

### SHORT DESCRIPTION OF THE DRAWINGS

These and further aspects of the present disclosure will be explained in greater detail by way of example and with reference to the accompanying drawings in which:

FIG. 1 represents a block diagram comprising method steps according to the method of the present disclosure, FIG. 2 schematically illustrates the carbon dioxide conversion method according to the present disclosure,

FIG. 3a illustrates the carbon dioxide conversion efficiency according to the present disclosure as function of time, for various ratios between atomic oxygen supply and carbon dioxide supply,

FIG. 3b illustrates a gas temperature inside the mixing area as function of time for various ratios between atomic oxygen supply and carbon dioxide supply,

FIG. 3c is a comparison between the carbon dioxide conversion efficiency obtained with the present method and an efficiency obtained with a classical thermal gas conversion.

FIG. 3d illustrates the carbon dioxide conversion efficiency as function of time for various pressure conditions inside the mixing area,

FIG. 4a illustrates a relation between the carbon dioxide conversion efficiency and a ratio between supplied atomic oxygen and supplied molecular oxygen for different CO2 fractions,

FIG. 4b illustrates a relation between the temperature in the mixing area and a ratio between supplied atomic oxygen and supplied molecular oxygen for different CO2 fractions,

FIG. 5 schematically illustrates an embodiment of an apparatus for conversion of carbon dioxide according to the present disclosure,

FIG. 6 schematically illustrates an embodiment of an apparatus for carbon dioxide conversion according to the present disclosure wherein the atomic oxygen generator is a plasma generator.

The drawings of the figures are neither drawn to scale nor proportioned. Generally, identical components are denoted by the same reference numerals in the figures.

### DETAILED DESCRIPTION OF EMBODIMENTS

The present disclosure will be described in terms of specific embodiments, which are illustrative of the disclosure and not to be construed as limiting. It will be appreciated by persons skilled in the art that the present disclosure is not limited by what has been particularly shown and/or described and that alternatives or modified embodiments could be developed in the light of the overall teaching of this disclosure. The drawings described are only schematic and are non-limiting.

Use of the verb “to comprise”, as well as the respective conjugations, does not exclude the presence of elements other than those stated. Use of the article “a”, “an” or “the” preceding an element does not exclude the presence of a plurality of such elements.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the disclosure described herein are capable of operation in other sequences than described or illustrated herein.

Reference throughout this specification to “one embodiment” or “an embodiment” means that a particular feature, structure or characteristic described in connection with the embodiments is included in one or more embodiment of the present disclosure. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one ordinary skill in the art from this disclosure, in one or more embodiments.

### Method for CO2 Conversion

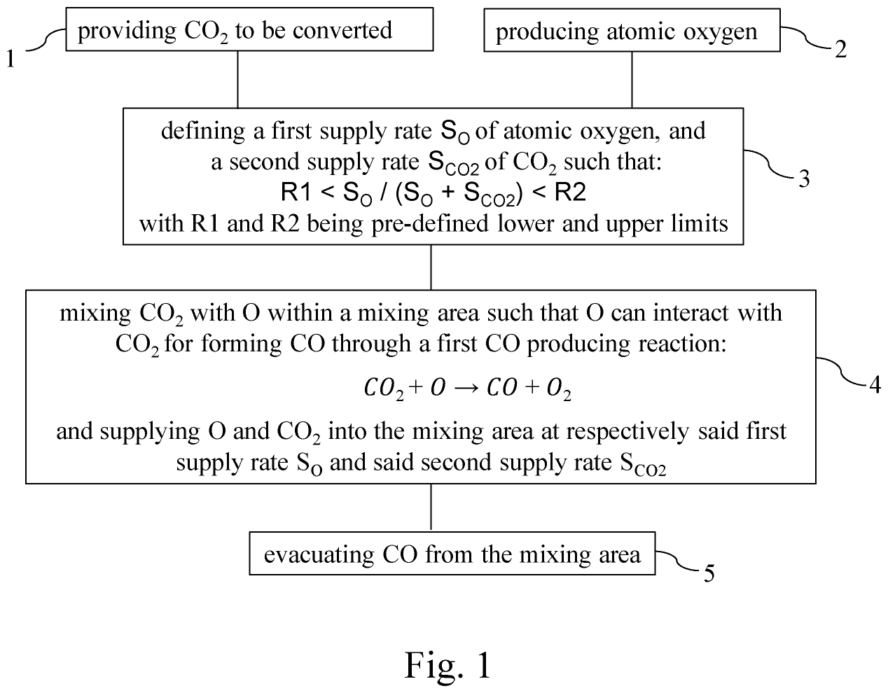

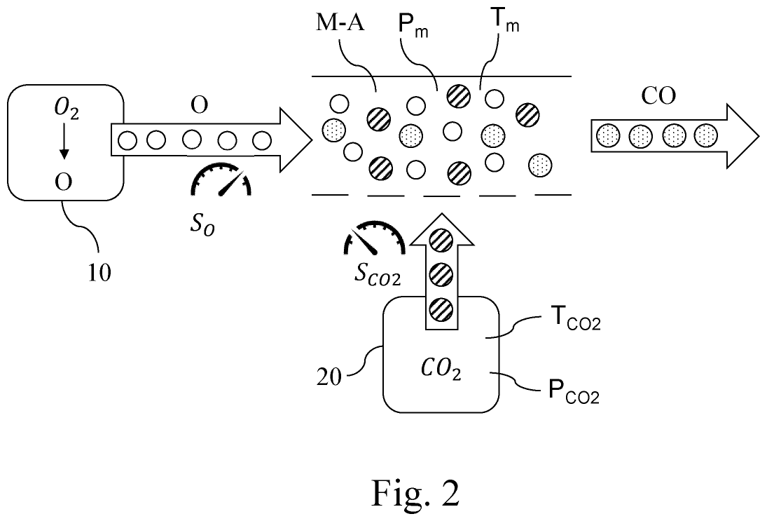

According to a first aspect of the present disclosure, a method for CO2 conversion is provided. With reference to FIG. 1, a block diagram is shown wherein steps 1 to 5 illustrate method steps performed with the method for carbon dioxide conversion according the present disclosure.

The method for carbon dioxide conversion according to the present disclosure comprises a first step 1 of providing the carbon dioxide to be converted and a second step 2 of producing atomic oxygen.

In embodiments, the CO2 that is to be converted is in a gaseous form.

As mentioned above, the CO2 to be converted can for example be CO2 coming from recapture or coming directly from CO2 producing exhausts.

The second step 2 of producing atomic oxygen will be discussed in more detail below when various methods to produce atomic oxygen are presented.

At step 4, the CO2 and the CO are mixed in a mixing area M-A, as schematically illustrated on FIG. 2.

With the present method, CO2 and O are supplied into the mixing area at a well-defined O/CO2 ratio. Therefore, the present method, at step 3, comprises defining a first supply rate S_{O} of atomic oxygen and defining a second supply rate S_{CO2} of carbon dioxide. The first and second supply rate are defined such that a ratio between the first supply rate and a sum of the first and second supply rate is comprised within a pre-defined lower R1 and a pre-defined upper threshold R2. In other words, R1<S_{O}/(S_{O}+S_{CO2})<R2, with S_{O} being the first supply rate of atomic oxygen, S_{CO2} the second supply rate of carbon, and wherein R1 and R2 are respectively the pre-defined lower and upper threshold.

Generally, the first supply rate and the second supply rate are corresponding to respectively a number of oxygen atoms supplied per unit of time and a number of carbon dioxide molecules supplied per unit of time into the mixing area M-A. However, the supply rates could also be expressed in terms of other units.

What the values for R1 and R2 are, or how to select these values will be discussed in more detail below. Generally, R1 ≥0.1 and R2≤0.9, preferably R1≥0.2 and R2≤0.8 and more preferably R1≥0.3 and R2≤0.7. Hence, the first supply rate of atomic oxygen should at least be lower than the second supply rate of carbon dioxide.

At step 4, while supplying the atomic oxygen and the carbon dioxide into the mixing area M-A at respectively the first supply rate S_{O} and the second supply rate S_{CO2}, the carbon dioxide will mix with the atomic oxygen within the mixing area M-A, and, as a result, the atomic oxygen can interact with the carbon dioxide for forming carbon monoxide within the mixing area M-A through a first CO producing reaction, namely: CO₂+O→CO+O₂. Hence, the present CO2 conversion method can also be named atomic oxygen driven CO2 conversion method.

Finally, at step 5, CO is evacuated from the mixing area. Generally, not only CO is evacuated but product gases are evacuated from the mixing area M-A and the product gases comprise at least CO. Product gases have to be construed as various species present in the mixing area, which besides CO can also comprise for example CO2 that is not converted or other gases present in the mixing area such as O2.

As schematically shown on FIG. 2, a gas temperature Tₘ and gas pressure Pₘ can be identified for the mixing area M-A.

To demonstrate what CO2 conversion yields are obtainable with the present atomic oxygen driven CO2 conversion method, a model calculation was performed wherein at a time t=0, CO2 and O start being supplied and mixed in the mixing area and wherein the changes of the mixture are followed over time. The model takes into account thermal neutral chemistry. The model calculates for instance density changes in a homogeneous volume element over time, including gas heating. Various species are included in the model, such as neutral ground state species, charged species and exited species. In a first set of calculations performed, no external power is applied to the mixing area.

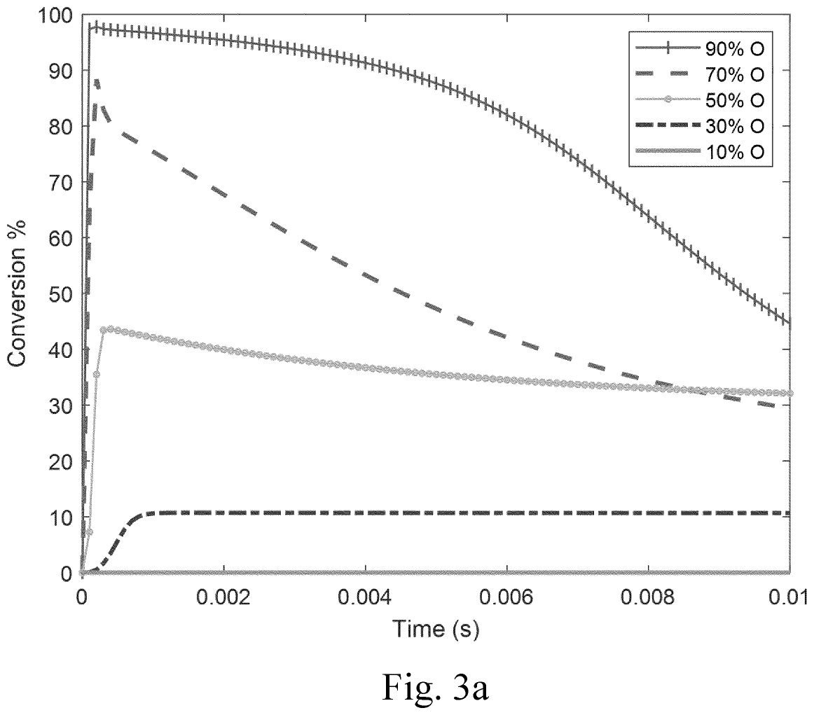

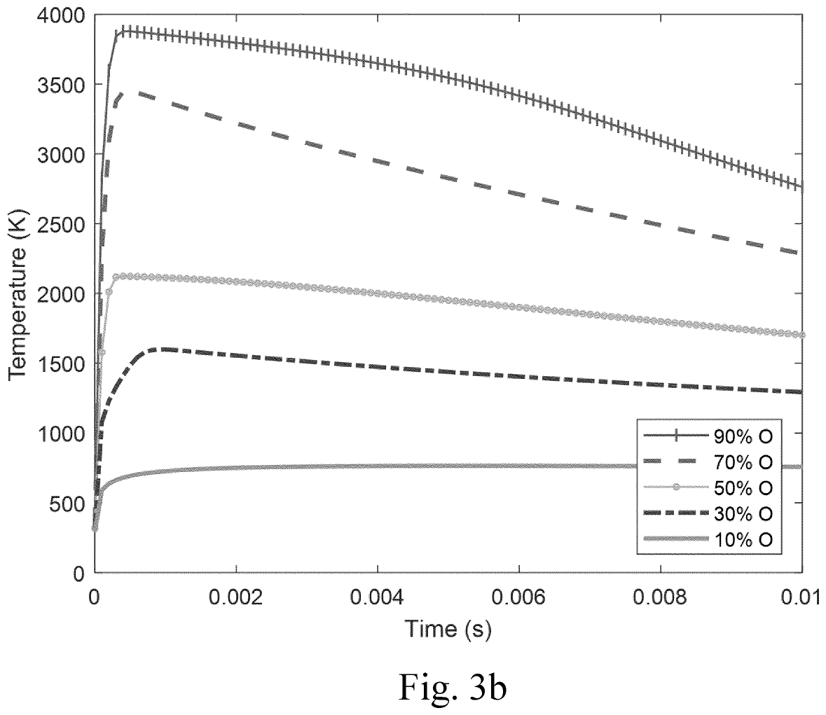

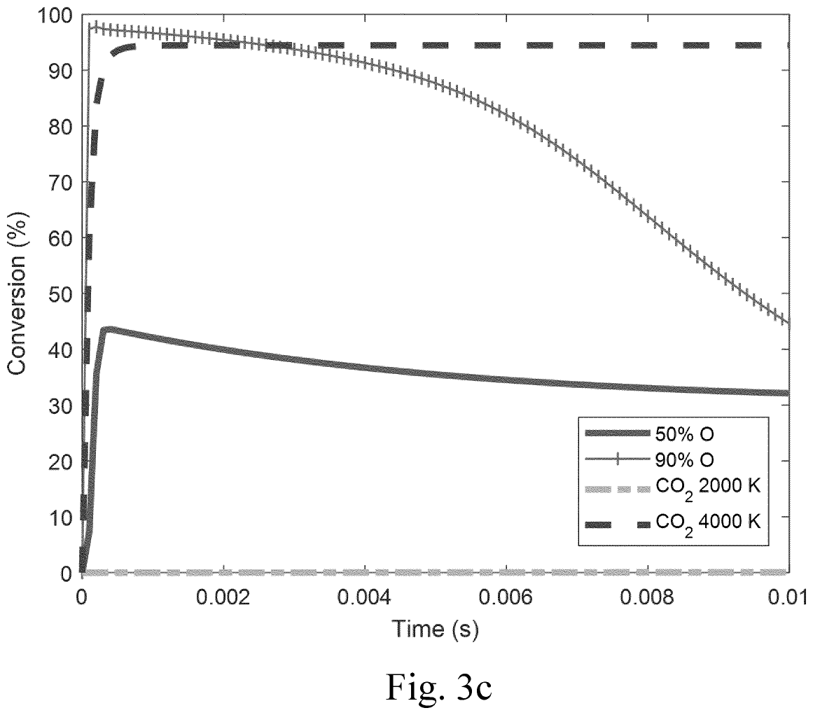

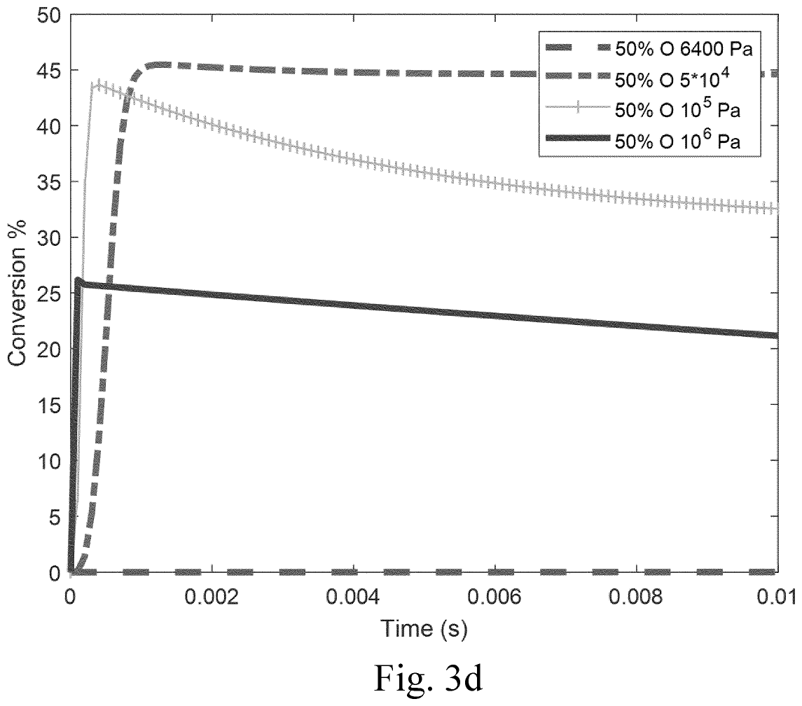

The results of the first set of calculations wherein no external heat is applied, are shown on FIG. 3a to FIG. 3d. On FIG. 3a, the CO2 conversion yield, expressed as a percentage value of converted CO2, is shown as function of time. On FIG. 3a, five curves are shown for different S_{O}/(S_{O}+S_{CO2}) ratios of 10%, 30%, 50%, 70% and 90%. Initially, the conversion yield is low but quickly raises thereafter to a maximum value. For the lowest 10% S_{O}/(S_{O}+S_{CO2}) ratio, the CO2 conversion yield is very low and is not visible on the linear scale of FIG. 3a. For a 30% S_{O}/(S_{O}+S_{CO2}) ratio, after having reached the maximum conversion, a plateau is reached of about 10% CO₂ conversion yield. For a 90% S_{O}/(S_{O}+S_{CO2}) ratio, maximum conversion values up to almost 100% can be reached. However, in this example, an optimum solution is obtained at a S_{O}/(S_{O}+S_{CO2}) ratio of about 50% where a maximum yield around 45% is obtained and where for example after a time period of 10 milliseconds, a steady-state condition is obtained where the conversion yield remains constant as function of time. In contrast with the curves at for example a 70% or a 90% S_{O}/(S_{O}+S_{CO2}) ratio, where a higher maximum conversion yield is obtained but where no steady-state condition is obtainable, and hence the conversion yields continue dropping as function of time after having reached the maximum value. For applying the present CO2 conversion method in an industrially set-up, a conversion yield that reaches a steady-state condition is of more practical use. Hence, this stresses the importance to well define and control the ratio S_{O}/(S_{O}+S_{CO2}) to obtain a CO2 conversion curve that is reaching a steady state condition.

In FIG. 3b, the gas temperature Tₘ in the mixing area is shown as function of time for the same S_{O}/(S_{O}+S_{CO2}) ratios as in FIG. 3a. The curves illustrate an initial increase of the temperature until a maximum temperature is reached. For high S_{O}/(S_{O}+S_{CO2}) ratios, after having reached the maximum temperature, the temperature strongly drops as function of time, as illustrated for example with the 70% and 90% curves. For low S_{O}/(S_{O}+S_{CO2}) ratios, following the maximum temperature, the temperature remains more or less constant, as illustrated with the 10% curve. For S_{O}/(S_{O}+S_{CO2}) ratios between 30% and 60% the temperature is only varying slowly as function of time after having reached the maximum temperature.

With the method according to the present disclosure, heat is produced in the mixing area through an exothermic recombination reaction, namely: O+O→O₂, which has a standard enthalpy ΔH° of −5.2 eV/molecule. Hence, even without any external supply of heat, a gas temperature Tₘ within the mixing area up to thousands degree Kelvin is obtained, as illustrated on FIG. 3b.

Even if initially starting at room temperature, the temperature in the mixing chamber raises due to this exothermic atomic oxygen recombination reaction. As illustrated on FIG. 3b, the higher the S_{O}/(S_{O}+S_{CO2}) ratios, the higher the temperature that can be reached in the mixing area. With high S_{O}/(S_{O}+S_{CO2}) ratios of 70% or more, temperatures above 3000° K are reached, which means that the CO2 thermal conversion limit is reached.

When these high temperatures of 3000° K and more are reached, thermal conversion of CO2 takes place, and hence CO is produced in the mixing area through a second CO producing reaction, being CO₂+M→CO+O+M with ΔH°=5.5 eV/molecule, with M being any neutral molecule, i.e. any neutral molecule present in the mixing area.

When at lower temperatures, for example at 2000° K, the CO production in the mixing area is dominated by the first CO producing reaction. This is illustrated on FIG. 3c, where the conversion yield obtained with the method according to the present disclosure, at 50% O and 90% O supply, is compared with pure thermal CO2 conversion at fixed temperatures of 2000° K and 4000° K, as obtained with a classical thermal CO2 conversion method using a heating source for heating the CO2 to be converted. With the present method, at 90% O supply, maximum conversion yields of up to 99% are obtained which are similar to the conversion yields obtained with the classical thermal conversion at 4000° K. However, as shown on FIG. 3b, with a 50% O supply, resulting in temperatures around 2000° K in the mixing area, a maximum conversion yield of around 40% is obtained, which is in contrast with the classical thermal conversion at the same temperature of 2000° K, where the CO conversion yield is below 1%.

On FIG. 3c, the CO conversion yield with the thermal conversion at 2000° K, which is lower than 1%, is not visible on the linear scale used for FIG. 3c. This illustrates, that with the present method wherein atomic oxygen is added to CO2, a high conversion yield can be obtained at lower temperatures, e.g. 2000° K, due to the first CO producing reaction discussed above.

The various curves shown on FIG. 3b illustrate that there is a direct relation between the gas temperature Tₘ in the mixing area and the supply ratio S_{O}/S_{CO2}. Hence by defining, at step 3 of the present method, the S_{O}/(S_{O}+S_{CO2}) ratios, one also controls the temperature Tₘ in the mixing area.

In embodiments, the method according the present disclosure further comprises a step of obtaining a gas temperature Tₘ in the mixing area M-A that is comprised within a temperature range of 500° K≤Tₘ≤3000° K, preferably 800° K≤Tₘ≤2500° K, more preferably 1000° K≤Tₘ≤2500° K. In this way, an occurrence of the first CO producing reaction being: CO₂+O→CO+O₂, is larger than an occurrence of the second CO producing reaction being CO₂+M→CO+O+M. In other words, by selecting the S_{O}/(S_{O}+S_{CO2}) ratio such that the gas temperature Tₘ in the mixing area remains below the thermal limit, an occurrence of the first CO producing reaction is larger than an occurrence of the second CO producing reaction.

In other embodiments, the method comprises maintaining a gas temperature Tₘ in the mixing area M-A within a temperature range of: 1500° K≤Tₘ≤2500° K.

In embodiments, the gas temperature Tₘ in the mixing area is controlled by controlling the first supply rate S_{O} and the second supply rate S_{CO2} such that the ratio between the first and second supply rate remains within the pre-defined lower and upper thresholds. Indeed as illustrated above with FIG. 3a and FIG. 3b, by well-defining the S_{O}/(S_{O}+S_{CO2}) ratio a gas temperature can be predicted.

By keeping the temperature in the mixing area below the extreme temperatures of for example 3000° K, ideally keeping the temperature as low as possible while maintaining a reasonable conversion yield, the practical implementation of the present method in terms of equipment and material choices can be facilitated. Generally, to maintain a reasonable conversion yield, the temperature is to be kept above 800° K. Also, as illustrated on FIG. 3a and FIG. 3b, by keeping the temperature in the mixing area for example around 2000° K, a steady state condition is obtained after one millisecond. A steady state condition also facilitates the evacuation of the product gases out of the mixing area as a constant conversion yield gives more flexibility for what concerns the time needed to evacuate the product gases and cool the product gas.

In embodiments, the method further comprises establishing a relation between the gas temperature Tₘ in the mixing area M-A and the ratio between the first S_{O} and second S_{CO2} supply rate. This relation can be established for example by a model calculation or by a calibration measurement comprising measuring the temperature in the mixing area as function of the ratio S_{O}/S_{CO2}.

In embodiments, the method further comprises defining the lower threshold R1 and the upper threshold R2 such that when controlling the ratio S_{O}/(S_{O}+S_{CO2}) to stay within the lower and upper threshold, a gas temperature within the required temperature range, for example between 1500° K and 2000° K, is obtained in the mixing area M-A.

As discussed above, in embodiments, no external energy source is used for heating the mixing area and obtaining the gas temperature Tₘ within the temperature range.

The pressure inside Pₘ in the mixing area M-A also plays a role as this influences the collision frequency between the atoms and molecules in the mixing area. For an embodiment wherein no external heating or cooling device is used, the influence of the pressure Pₘ in the mixing area is illustrated on FIG. 3d where the CO conversion yield is plotted for a 50% atomic oxygen supply and for various pressure regimes in the mixing area ranging from a pressure of 6400 Pa to 10⁶ Pa. These results show that with a pressure of about 5 10⁴ Pa, the best results are obtained and a conversion yield of about 45% is reached. At lower pressure, e.g. 6400 Pa, the conversion yield is very low and not visible on the linear scale of FIG. 3d. At higher pressure, e.g. 10⁵ Pa and 10⁶ Pa, the CO conversion yield is lower than the optimum results obtained at 5 10⁴ Pa.

In embodiments, the present method comprises maintaining a gas pressure Pₘ inside the mixing area M-A within pressure limits such that 10³ Pas Pₘ≤10⁶ Pa, preferably 10³ Pa≤Pₘ≤10⁵ Pa, more preferably 10⁴ Pa≤Pₘ≤ 10⁵ Pa, with Pₘ being the pressure within the mixing area M-A.

The expression “maintaining a gas pressure” refers to keeping the pressure inside the mixing area M-A between the limits as defined above. Preferably Pm varies maximum+/−15%, more preferably maximum+/−10%, more preferably maximum, +/−5%, more preferably maximum, +/−1%, more preferably maximum+/−0.1%.

As discussed above, and shown on FIG. 3a, for specific S_{O}/(S_{O}+S_{CO2}) ratios, a steady state condition, i.e. a constant CO conversion yield, can be obtained if the chemical reactions in the mixing area take place for a sufficiently long period of time, before the product gases are evacuated from the mixing area. Hence, in embodiments, the present method comprises allowing the atomic oxygen and the carbon dioxide to interact within the mixing area M-A during a minimum time period longer than 0.1 milliseconds, preferably longer than 0.5 milliseconds, more preferably longer than one millisecond.

At step 2, the production of atomic oxygen can be performed by various means known in the art. In embodiments, atomic oxygen is produced with any of the following atomic oxygen producing methods: utilizing a plasma, utilizing thermal heat, utilizing UV, or utilizing any other suitable method for producing atomic oxygen.

In embodiments, the atomic oxygen is produced starting from an O₂ gas.

In embodiments the atomic oxygen is not supplied as pure atomic oxygen but the atomic oxygen can be supplied into the mixing area as for example a combination of atomic oxygen and molecular oxygen. Typically, when the atomic oxygen is produced with a plasma, both atomic oxygen and molecular oxygen will be present in the plasma and hence be supplied to the mixing area.

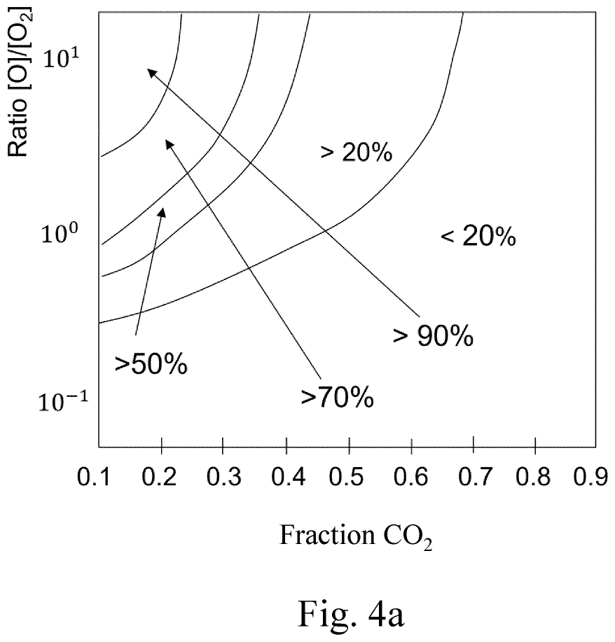

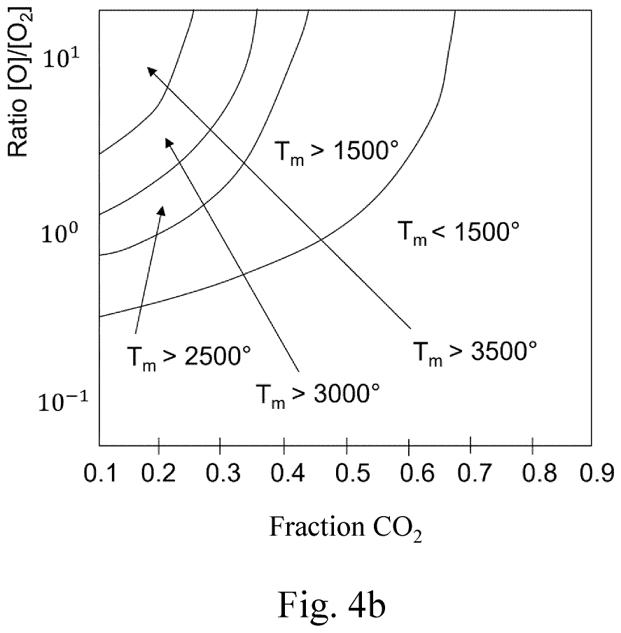

If both atomic and molecular oxygen are supplied in the mixing area, the ratio of atomic oxygen versus molecular oxygen has an influence on the CO conversion yield. This is schematically illustrated on FIG. 4a wherein the vertical axis is the ratio O/O2 and the horizontal axis is the fraction of CO2 defined as being equal to S_{CO2}/(S_{CO2}+S_{O}+S_{O2}) and wherein bands of higher and lower maximum conversion yields can be identified. The higher the O/O2 ratio, the higher the maximum CO conversion yield, and the smaller the CO2 fraction the higher the maximum CO conversion yield. The observation of these bands is directly linked with the temperature in the mixing area which also has a band structure when plotted as function of the O/O2 ratio and the CO2 fraction, as schematically illustrated on FIG. 4b. For a given O/O2 ratio, by adequately defining the CO2 fraction, an optimum band can be selected, for example a band wherein the temperature is above 1500° K and below 2500° K.

In embodiments wherein both atomic oxygen and molecular oxygen are supplied, the method comprises maintaining a ratio between the atomic oxygen supplied and the molecular oxygen supplied equal or larger than a minimum value: S_{O}/S_{O2}≥0.10, preferably S_{O}/S_{O2}≥0.20, more preferably S_{O}/S_{O2}≥0.30, with S_{O2} being a third supply rate of molecular oxygen. The third supply rate corresponds for example to a number of oxygen molecules supplied per unit of time into the mixing area. In other embodiments, the third supply rate can also be expressed in other units.

As discussed above, for the first set of calculations illustrated on FIG. 3a to FIG. 3d, FIG. 4a and FIG. 4b, no external power is applied to the mixing area to heat the mixing area or to cool the mixing area.

In alternative embodiments, either a heating device or a cooling device can be used to keep the temperature in the mixing area at a pre-defined optimum temperature, for example at a temperature of 2000° K, or any other suitable temperature between for example 1500° K and 2500° K. Depending on the S_{O}/(S_{O}+S_{CO2}) ratio, either the mixing area needs heating or needs cooling to reach or maintain the optimum temperature. For example if the S_{O}/(S_{O}+S_{CO2}) ratio is relatively low, for example 30%, the maximum temperature that can be reached without heating is about 1500° K, as shown on FIG. 3b. By using a heating device the temperature can be raised to 2000° K. On the other hand, if the S_{O}/(S_{O}+S_{CO2}) ratio is relatively high, for example 70%, the maximum temperature is about 3500° K, as shown on FIG. 3b, and by using a cooling device, the temperature can be kept at a lower temperature of for example 2000° K. By providing the option of heating or cooling the mixing area, more ratios of S_{O}/S_{CO2}, allow for a good conversion yield. For example, by cooling the gas mixture down, backward reactions producing CO2 are reduced and a steady state condition can also be achieved at higher S_{O}/(S_{O}+S_{CO2}) ratios, resulting in a higher CO conversion yield.

Hence, in embodiments, the present method comprises maintaining a gas temperature Tₘ in the mixing area M-A at a pre-defined optimum temperature value within a margin of maximum 15%, preferably maximum 10%, more preferably maximum 5%: Tₘ₋ₒₚₜ-ER≤Tₘ≤Tₘ₋ₒₚₜ+ER, with Tₘ being the gas temperature in the mixing area and Tₘ₋ₒₚₜ being the pre-defined optimum gas temperature value and ER being the margin, and using a heating and/or cooling device for heating and/or cooling the mixing area M-A so as to maintain the gas temperature equal to the optimum temperature value within the margin.

A second set of calculations performed at a constant temperature of 2000° K, involving heating and cooling depending on the S_{O}/(S_{O}+S_{CO2}) ratio, reveal that the CO2 conversion yield, when plotted as in FIG. 4a, reveal that the surface area of the band of low conversion yield, i.e. below 20% is much lower, and hence there is a larger flexibility in selecting the O/O2 ratio and the fraction CO2 for obtaining a good conversion yield, e.g. of 50% or more.

As schematically illustrated on FIG. 2, in embodiments, the mixing of the carbon dioxide with the atomic oxygen within the mixing area M-A comprises steps of: i) generating a first stream of atomic oxygen and allow the first stream to flow through the mixing area, and ii) generating a second stream of carbon dioxide and inject the second stream into the mixing area such that the first stream of atomic oxygen and the second stream of carbon dioxide mix.

In embodiments, these streams of atomic oxygen and carbon dioxide have to be construed as gas flow streams.

In embodiments as schematically shown on FIG. 2, the first stream of atomic oxygen is flowing in a first direction and the second stream of carbon dioxide is flowing in a second direction, and wherein the second direction is transverse to the first direction.

### Apparatus for CO2 Conversion

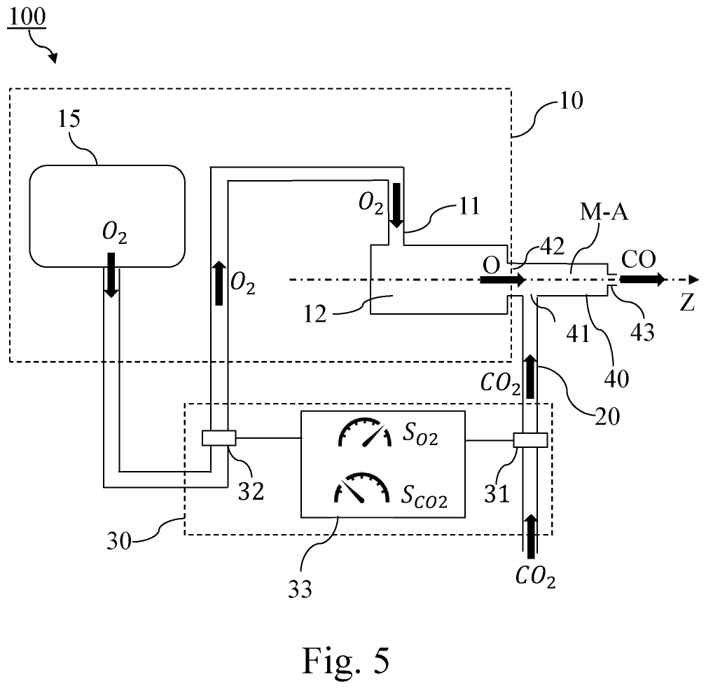

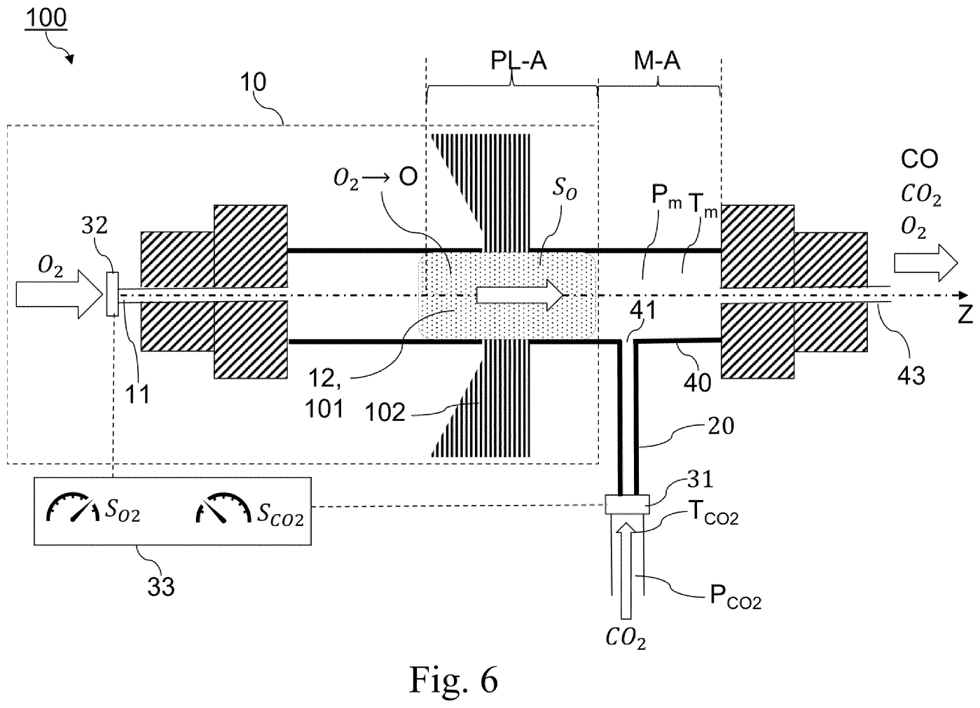

According to a second aspect of the present disclosure, an apparatus for CO2 conversion is provided. With reference to FIG. 5 and FIG. 6, examples of embodiments of an apparatus 100 for converting carbon dioxide into carbon monoxide are shown. The apparatus allows to implement the atomic oxygen driven method for CO2 conversion as discussed above.

The expression “configured for” is non limitative and could be replaced by ‘for’. The expression is solely used to clarify the embodiments and the functions intended to be performed by the features.

The apparatus 100 for CO2 conversion according to the present disclosure comprises an atomic oxygen generator 10 for producing atomic oxygen, a mixing area M-A configured for mixing the produced atomic oxygen with carbon dioxide to be converted, a carbon dioxide supply 20 configured for supplying carbon dioxide to be converted to the mixing area, a control device 30 configured for controlling a first supply rate of atomic oxygen S_{O} and controlling a second supply rate of carbon dioxide S_{CO2}, and a gas outlet 43 configured for evacuating product gases comprising carbon monoxide from the mixing area M-A.

As discussed above, the first supply rate S_{O} and the second supply rate S_{CO2} correspond respectively to a number of oxygen atoms supplied per unit of time into the mixing area and a number of carbon dioxide molecules supplied per unit of time into the mixing area. By providing a mixing area for mixing atomic oxygen with carbon dioxide, when the apparatus 100 is in operation, atomic oxygen can interact with carbon dioxide within the mixing area M-A for forming carbon monoxide through a first reaction: CO₂+O→CO+O₂.

In embodiments, the control device 30 is configured for controlling the first supply rate of atomic oxygen S_{O} and the second supply rate of carbon dioxide S_{CO2} such that a ratio between the first supply rate and the sum of the first and the second supply rate remains within a lower and upper threshold: R1<S_{O}/(S_{O}+S_{CO2})<R2, with S_{O} being the first supply rate of atomic oxygen, S_{CO2} the second supply rate of carbon dioxide, and wherein R1 and R2 are respectively the lower and upper threshold.

In embodiments, the lower R1 and upper R2 threshold are pre-defined thresholds.

As discussed above, when the discussing the method according to the present disclosure, also for the apparatus, those lower and upper thresholds are selected such that R1≥0.1 and R2≤0.9, preferably R1≥0.2 and R2≤0.8, more preferably R1≥0.3 and R2≤0.7.

In embodiments, as schematically shown on FIG. 5, the control device 30 can for example comprise one or more flow control valves 31, 32 that are controlled by a controller 33. By controlling the flow control valves a gas supply rate can be controlled.

In embodiments, the apparatus comprises a user interface for inputting values for the lower R1 and upper R2 threshold. These values can then be stored in a memory of the apparatus. In other embodiments, the values R1 and R2 can be defined through a calibration procedure and the resulting values R1 and R2 can be stored in a memory of the apparatus and be used for controlling the S_{O}/(S_{O}+S_{CO2}) ratio.

In more advanced embodiments, the control device 30 comprises a controller 33 and a computer program that when executed by the controller determines the lower R1 and upper R2 threshold in order to obtain a required gas temperature T_{m-req} in the mixing area. This determination of the R1 and R2 thresholds can be based on a pre-defined mathematical or tabular relation between a gas temperature Tₘ in the mixing area M-A and the ratio S_{O}/S_{CO2}. In these embodiments, the apparatus comprises a user interface configured for entering the required gas temperature T_{m-req} for the mixing area and/or a memory for storing the required gas temperature T_{m-req} for the mixing area.

The pre-defined mathematical or tabular relation can be defined based on a calibration procedure.

In embodiments, the required gas temperature T_{m-req} is selected to be within a temperature range: 500° K≤T_{m-req}≤3000° K, preferably 800° K≤T_{m-req}≤ 2500° K, more preferably 1000° K≤T_{m-req}≤2500° K, with T_{m-req} being the required gas temperature in the mixing area M-A. In this way, an occurrence of the first CO producing reaction: CO₂+O→CO+O₂ with ΔH°=0.3 eV/molecule, is larger than an occurrence of the second CO producing reaction: CO₂+M→CO+O+M with ΔH°=5.5 eV/molecule, with ΔH° being the standard enthalpy for the reactions, and with M being any neutral molecule.

In embodiments, as schematically illustrated on FIG. 5, the atomic oxygen generator 10 is configured for converting molecular oxygen into atomic oxygen. In these embodiments, the generator 10 comprises an oxygen conversion area 12 wherein molecular oxygen is converted into atomic oxygen, and an oxygen supply 11 for supplying molecular oxygen to the oxygen conversion area 12.

In embodiments, the oxygen supply 11 is receiving O2 from a reservoir 15 containing molecular oxygen. The reservoir can for instance be an O2 gas bottle or tank.

In embodiments, the control device 30 is configured for indirectly controlling the first supply rate of atomic oxygen S_{O} by controlling a third supply rate of molecular oxygen Soz being supplied through the oxygen supply 11.

The control device 30 comprises for example a gas flow controlling valve 32 for controlling the molecular oxygen O2 supply rate. Indeed, the atomic oxygen generator has a specific molecular to atomic oxygen conversion efficiency, corresponding to the number of oxygen atoms produced per supplied O2 molecule. Hence, there is relation between produced atomic oxygen and supplied molecular O2.

In embodiments, the control device 30 is configured for controlling the first supply rate of atomic oxygen by using a pre-defined relation between supplied molecular oxygen to the oxygen conversion area 12 and produced atomic oxygen in the oxygen conversion area 12.

In embodiments, a first flow control valve 31 can be used to control the supply of CO2 to the mixing area and a second flow control valve 32 can be used to control the supply of molecular oxygen to the atomic oxygen generator 10. The control device can also comprise a controller 33 that controls the valves and allows for example to vary a valve setting, and wherein a variation of a valve setting results in a variation of a supply rate.

In embodiments, the control device 30 is configured for maintaining a gas temperature Tₘ in the mixing area M-A within a temperature range of: 500° K≤ Tₘ≤3000° K, preferably 800° K≤Tₘ≤2500° K, more preferably 1000° K≤Tₘ≤ 2500° K. As mentioned above, in this way, an occurrence of the first CO producing reaction: CO₂+O→CO+O₂ is larger than an occurrence of a second CO producing reaction: CO₂+M→CO+O+M.

In other embodiments, the control device 30 is configured for maintaining a gas temperature Tₘ in the mixing area M-A within a temperature range of:

$$1500 ° K \leq {T}_{m} \leq 2500 ° K .$$

In embodiments, the control device 30 is configured for maintaining the gas temperature within the temperature range by controlling the ratio between the first supply rate and the second supply rate such that the ratio between the first and second supply rate remains within the pre-defined lower R1 and upper R2 thresholds during operation of the apparatus.

As discussed above, the pressure Pₘ in the mixing area M-A is within pressure limits. For example, for embodiments wherein no external heating or cooling device is used for heating or cooling the mixing area, the pressure limits are for example 10³ Pa≤Pₘ≤10⁶ Pa, preferably 10³ Pa≤Pₘ≤10⁵ Pa, more preferably 10⁴ Pa≤Pₘ≤10⁵ Pa, with Pₘ being the pressure within the mixing area M-A. In embodiments, to maintain the pressure within limits, a dimension of the gas outlet 43 and/or a pump coupled to the gas outlet 43 is configured for maintaining a gas pressure Pₘ in the mixing area (M-A) within the pressure limits defined.

The volume of the mixing area plays also a role as it determines how long the species remain in the mixing area before being evacuated. As discussed above and illustrated on FIG. 3a and FIG. 3b, time plays a role, depending for instance if one wants to evacuate the CO when reaching maximum CO conversion or only after a steady state condition is reached.

In embodiments, the volume of the mixing area M-A and the dimension of the gas outlet 43 and/or the pump are configured for allowing the atomic oxygen and the carbon dioxide molecules to interact within the mixing area during a minimum time period longer than 0.1 milliseconds, preferably longer than 0.5 milliseconds, more preferably longer than one millisecond.

In embodiments, as schematically illustrated on FIG. 5, the apparatus 100 according to the present disclosure comprises a mixing chamber 40 elongating along a longitudinal axis Z and wherein the mixing chamber is delimiting the mixing area M-A. The mixing chamber 40 comprises: a) an axial entrance 41 configured for receiving the atomic oxygen produced by the atomic oxygen generator 10, b) one or more inlet openings 41 configured for supplying the carbon dioxide to the mixing chamber 40, and c) an outlet opening for evacuating product gas comprising carbon monoxide from the mixing chamber. The outlet opening of the mixing chamber corresponds to the gas outlet 43 of the apparatus. In embodiments, the one or more inlet openings are radial inlet openings with respect to the longitudinal axis.

The mixing chamber 40 is generally made of a material having a high melting point and the material can be selected depending on what temperature range the apparatus is operating in. The walls of the mixing chamber can for example be made or partly be made of a high-melting point metal such as tungsten, tantalum or any other suitable metal. In other embodiments the mixing chamber can be made out of for example ceramic, glass or zirconia.

In embodiments, as schematically illustrated on FIG. 5, the atomic oxygen generator 10 is configured for generating a stream of atomic oxygen flowing through the mixing area M-A in a first direction. For example on FIG. 5, a black arrow O indicates the flow of atomic oxygen in a direction parallel with the longitudinal axis Z. The carbon dioxide supply 20 is configured for injecting the carbon dioxide into the mixing area M-A in a second direction transversal to the first direction. A black arrow CO2, indicated on FIG. 5, is schematically illustrating a CO2 gas flow perpendicular with the longitudinal axis Z that is injected in the mixing area.

Depending on what application the apparatus is used for, the CO2 to be converted can either be the result of a capture process or the apparatus can be coupled to an exhaust producing CO2.

In embodiments, the carbon dioxide supply 20 that is supplying the CO2 to the mixing area, is configured for supplying the carbon dioxide to the mixing area M-A at a gas supply pressure P_{CO2} and a gas temperature T_{CO2}. In embodiments, 10³ Pa≤P_{CO2}≤10⁶ Pa, preferably 10³ Pa≤P_{CO2}≤10⁵ Pa, and with 200° K≤T_{CO2}≤400° K, preferably 250° K≤T_{CO2}≤350° K, more preferably 270° K≤T_{CO2}≤320° K. In other words, there are no high constraints or demands for what concerns pressure and temperature of the CO2 to be converted before being injected in the mixing area. Generally the pressure P_{CO2} is taken to be larger than the pressure Pₘ in the mixing chamber such that the CO2 is being injected in the mixing chamber due to the overpressure.

In embodiments as illustrated on FIG. 6, the atomic oxygen generator 10 is a plasma generator configured for producing a plasma 101 comprising at least atomic oxygen and molecular oxygen, and wherein the oxygen conversion area 12 corresponds to a plasma area PL-A for forming the plasma 101.

In the example shown on FIG. 6, the plasma reactor is a microwave reactor comprising a wave guide 102 to provide the necessary power to sustain the plasma. In other embodiments the plasma reactor can be another type of plasma reactor such as for example a gliding arc plasma reactor or a glow discharge plasma reactor.

In embodiments wherein the atomic oxygen generator is a plasma reactor, the mixing area M-A is located adjacently to the plasma area PL-A and configured such that when the plasma generator is in operation, atomic oxygen is flowing from the plasma area to the mixing area.

In embodiments, the oxygen produced in the plasma area PL-A, will flow together with molecular oxygen towards the mixing area M-A, for example in a direction parallel with a longitudinal axis Z, as schematically shown on FIG. 6.

In some embodiments, as schematically illustrated on FIG. 6, the mixing chamber 40 can be an extension of a plasma chamber that is confining the plasma. For example, a tubular chamber can be used wherein a first portion of the chamber is forming the plasma chamber and a second, adjacent portion, is forming the mixing chamber.

In embodiments, the mixing area M-A is at least partly coinciding with the plasma area PL-A. In these embodiments, the carbon dioxide supply is preferably injecting the CO2 into the mixing area in a region where the plasma area is coinciding with the mixing area. In these embodiments wherein the plasma area partly coincides with the mixing area, the first supply rate of atomic oxygen corresponds to a production rate of atomic oxygen within the plasma area.

In embodiments, the atomic oxygen generator is using thermal energy for producing atomic oxygen.

In further embodiments, the atomic oxygen generator is using UV radiation for producing atomic oxygen.

In embodiments, as discussed above, the mixing area can also be cooled or heated in order to keep the temperature in the mixing area at a pre-defined temperature, for example 2000° K. In these embodiments, the apparatus comprises a heating and/or cooling device configured for heating and/or cooling the mixing area M-A so as to maintain a gas temperature Tₘ in the mixing area equal to an optimum temperature value Tₘ-opt within a margin, and wherein the margin is maximum 15%, preferably maximum 10%, more preferably maximum 5%, such that: Tₘ₋ₒₚₜ-ER≤Tₘ≤Tₘ₋ₒₚₜ+ER, with Tₘ being the actual gas temperature in the mixing area and Tₘ₋ₒₚₜ being the pre-defined optimum gas temperature value and ER being the margin.

In embodiments the control device 30 is further configured for controlling the temperature in the mixing area. In these embodiments, the control device 30 comprises for example a temperature probe configured for measuring the temperature inside the mixing area. In embodiments, the controller 33 is coupled with the heating and/or cooling device and configured for controlling the amount of heating and/or cooling generated by the heating and/or cooling device as function of the temperature measured in the mixing area.

In some embodiments, the apparatus (100) for converting carbon dioxide into carbon monoxide comprises:
an atomic oxygen generator (10) for producing atomic oxygen,
a mixing area (M-A),
a carbon dioxide supply (20),
a control device (30), and
a gas outlet (43).

In further embodiments, the apparatus (100) for converting carbon dioxide into carbon monoxide comprises:
an atomic oxygen generator (10) for producing atomic oxygen,
a mixing area (M-A) for mixing the produced atomic oxygen with carbon dioxide to be converted such that when the apparatus is in operation, atomic oxygen can interact with the carbon dioxide within the mixing area (M-A) for forming carbon monoxide through a first CO producing reaction: CO2+O→CO+O2,
a carbon dioxide supply (20) for supplying carbon dioxide to be converted to the mixing area (M-A),
a control device (30) for controlling a first supply rate of atomic oxygen (S_{O}) supplied to the mixing area and controlling a second supply rate of carbon dioxide (S_{CO2}) supplied to the mixing area such that:

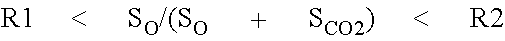

with S_{O} being said first supply rate of atomic oxygen, S_{CO2} said second supply rate of carbon dioxide, and wherein R1 and R2 are respectively a lower and an upper threshold, and
a gas outlet (43) for evacuating carbon monoxide from the mixing area (M-A).

### Detailed Characterizations

Here below, text is provided in the form of clauses. The clauses comprise characterizations indicating a variety of options, features, and feature combinations that can be used in accord with the teachings of the present disclosure. Alternate characterizations of the ones given, but consistent with the descriptions herein above, are possible

In summary, according to the present disclosure, the following list of clauses could for instance be claimed:
1. A method for converting carbon dioxide into carbon monoxide comprising:
   providing carbon dioxide to be converted,
   producing atomic oxygen,
   mixing the carbon dioxide with the atomic oxygen within a mixing area (M-A) such that the atomic oxygen can interact with the carbon dioxide for forming carbon monoxide within the mixing area (M-A) through a first CO producing reaction:

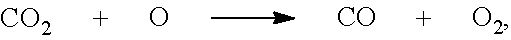

evacuating carbon monoxide from the mixing area (M-A).
2. A method for converting carbon dioxide into carbon monoxide comprising:
   providing carbon dioxide to be converted,
   producing atomic oxygen,
   defining a first supply rate (S_{O}) of atomic oxygen and a second supply rate (S_{CO2}) of carbon dioxide such that:

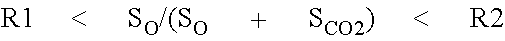

with S_{O} and S_{CO2} being respectively said first supply rate and said second supply rate, and wherein R1 and R2 are respectively a pre-defined lower and a pre-defined upper threshold,
mixing the carbon dioxide with the atomic oxygen within a mixing area (M-A) such that the atomic oxygen can interact with the carbon dioxide for forming carbon monoxide within the mixing area (M-A) through a first CO producing reaction:

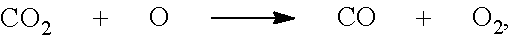

and supplying the atomic oxygen and carbon dioxide into the mixing area (M-A) at respectively said first supply rate (S_{O}) and said second supply rate (S_{CO2}),
evacuating carbon monoxide from the mixing area (M-A).
3. The method of clause 1 wherein a first supply rate (S_{O}) of atomic oxygen and a second supply rate (S_{CO2}) of carbon dioxide is defined such that:

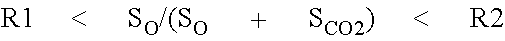

wherein R1 and R2 are respectively a pre-defined lower and a pre-defined upper threshold, wherein R1≥0.1 and R2≤0.9, preferably R1≥0.2 and R2≤0.8, more preferably R1≥0.3 and R2≤0.7.
4. The method of clause 2 wherein R1≥0.1 and R2≤0.9, preferably R1≥0.2 and R2≤0.8, more preferably R1≥0.3 and R2≤0.7.
5. The method according to clause 2 or clause 4 wherein heat is produced in the mixing area (M-A) through a recombination reaction:
   O+O→O₂ and wherein ΔH°=−5.2 eV/molecule, with ΔH° being a standard enthalpy for the recombination reaction.
6. The method according to clause 5 comprising:
   obtaining a gas temperature (Tₘ) in said mixing area (M-A) that is comprised within a temperature range:
      500° K≤Tₘ≤3000° K, preferably 800° K≤Tₘ≤2500° K, more preferably 1000° K≤Tₘ≤2500° K,
   with Tₘ being said gas temperature in the mixing area (M-A), such that an occurrence of the first CO producing reaction:

CO₂+O→CO+O₂ with ΔH°=0.3 eV/molecule,
is larger than an occurrence of a second CO producing reaction:

CO₂+M→CO+O+M with ΔH°=5.5 eV/molecule,
with ΔH° being a standard enthalpy for the respective CO producing reactions, and with M being any neutral molecule.
7. The method according to clause 6 wherein said gas temperature (Tₘ) in the mixing area is obtained by controlling the first supply rate and the second supply rate such that said ratio between the first and second supply rate remains within the pre-defined lower and upper thresholds.
8. The method according to any of clauses 6 to 7 comprising
   establishing a relation between the gas temperature (Tₘ) in the mixing area (M-A) and said ratio S_{O}/(S_{O}+S_{CO2}), and
   defining said lower threshold R1 and said upper threshold R2 such that when controlling the ratio S_{O}/(S_{O}+S_{CO2}) within the lower and upper threshold, a gas temperature within said temperature range is obtained in the mixing area (M-A).
9. The method according to any of clauses 6 to 8 wherein no external energy source is used for heating said mixing area and obtaining said gas temperature (Tₘ) within said temperature range.
10. The method according to any of clauses 2, 4 or 5 comprising:
   maintaining a gas temperature (Tₘ) in said mixing area (M-A) at a pre-defined optimum temperature value within a margin of maximum 15%, preferably maximum 10%, more preferably maximum 5%:

$${T}_{m - opt} - ER \leq {T}_{m} \leq {T}_{m - opt} + ER ,$$

with Tₘ being the gas temperature in the mixing area and Tₘ-opt being said pre-defined optimum gas temperature value and ER being said margin,
and using a heating and/or cooling device for heating and/or cooling said mixing area (M-A) so as to maintain the gas temperature (Tₘ) in said mixing area (M-A) equal to the optimum temperature value within the margin.
11. The method according to any of previous clauses wherein the carbon dioxide to be converted is supplied into the mixing area (M-A) in a gaseous form at a gas supply temperature T_{CO2} with 200° K≤T_{CO2}≤400° K, preferably 250° K≤T_{CO2}≤350° K, more preferably 270° K≤T_{CO2}≤320° K.
12. The method according to clause 11 wherein the carbon dioxide to be converted is supplied into the mixing area (M-A) at a gas supply pressure (P_{CO2}), wherein
   10³ Pa≤P_{CO2}≤10⁶ Pa, preferably 10³ Pa≤P_{CO2}≤10⁵ Pa, with P_{CO2} being said gas supply pressure.
13. The method according to any of previous clauses comprising:
   maintaining a gas pressure (Pₘ) inside said mixing area (M-A) within pressure limits such that
10³ Pa≤Pₘ≤10⁶ Pa, preferably 10³ Pa≤Pₘ≤10⁵ Pa, more preferably 10⁴ Pa≤Pₘ≤10⁵ Pa, with Pₘ being the pressure within said mixing area (M-A).
14. The method according to any of previous clauses comprising:
   allowing the atomic oxygen and the carbon dioxide to interact within the mixing area (M-A) during a minimum time period longer than 0.1 milliseconds, preferably longer than 0.5 milliseconds, more preferably longer than one millisecond.
15. The method according to any of previous clauses wherein the atomic oxygen is produced starting from an O₂ gas.
16. The method according to any of previous clauses wherein the atomic oxygen is supplied into the mixing area as a combination of atomic oxygen and molecular oxygen.
17. The method according to clause 16 comprising:
   maintaining a ratio between the atomic oxygen supplied and the molecular oxygen supplied equal or larger than a minimum value: S_{O}/S_{O2}≥0.10, preferably S_{O}/S_{O2}≥0.20, more preferably S_{O}/S_{O2}≥0.30, with Soz being a third supply rate of molecular oxygen.
18. The method of any of previous clauses wherein said mixing the carbon dioxide with the atomic oxygen within the mixing area (M-A) comprises steps of:
   i) generating a first stream of atomic oxygen and allow the first stream to flow through the mixing area, and
   ii) generating a second stream of carbon dioxide and inject the second stream into the mixing area such that the first stream of atomic oxygen and the second stream of carbon dioxide mix.
19. The method of clause 18 wherein said first stream of atomic oxygen is flowing in a first direction and said second stream of carbon dioxide is flowing in a second direction, and wherein the second direction is transverse to the first direction.
20. The method according to any of previous clauses wherein the atomic oxygen is produced with any of the following atomic oxygen producing methods: utilizing a plasma, utilizing thermal heat, utilizing UV, or utilizing any other suitable method for producing atomic oxygen.
21. The method according to any of previous clauses wherein said first supply rate (S_{O}) of atomic oxygen corresponds to a first number of oxygen atoms supplied per unit of time, and said second supply rate (S_{CO2}) of carbon dioxide corresponds to a second number of carbon dioxide molecules supplied per unit of time.
22. The method according to clause 16 wherein said third supply rate (S_{O2}) corresponds to a number of oxygen molecules supplied per unit of time into the mixing area.
23. An apparatus (100) for converting carbon dioxide into carbon monoxide comprising:
   an atomic oxygen generator (10) for producing atomic oxygen,
   a mixing area (M-A),
   a carbon dioxide supply (20),
   a control device (30), and
   a gas outlet (43.
24. An apparatus (100) for converting carbon dioxide into carbon monoxide comprising:
   an atomic oxygen generator (10) for producing atomic oxygen,
   a mixing area (M-A) for mixing the produced atomic oxygen with carbon dioxide to be converted such that when the apparatus is in operation, atomic oxygen can interact with the carbon dioxide within the mixing area (M-A) for forming carbon monoxide through a first CO producing reaction: CO₂+O→CO+O₂,
   a carbon dioxide supply (20) for supplying carbon dioxide to be converted to the mixing area (M-A),
   a control device (30) for controlling a first supply rate of atomic oxygen (S_{O}) supplied to the mixing area and controlling a second supply rate of carbon dioxide (S_{CO2}) supplied to the mixing area such that:

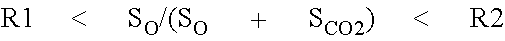

with S_{O} being said first supply rate of atomic oxygen, S_{CO2} said second supply rate of carbon dioxide, and wherein R1 and R2 are respectively a lower and an upper threshold, and
a gas outlet (43) for evacuating carbon monoxide from the mixing area (M-A).
25. An apparatus (100) for converting carbon dioxide into carbon monoxide comprising:
   an atomic oxygen generator (10) for producing atomic oxygen,
   a mixing area (M-A) configured for mixing the produced atomic oxygen with carbon dioxide to be converted such that when the apparatus is in operation, atomic oxygen can interact with the carbon dioxide within the mixing area (M-A) for forming carbon monoxide through a first CO producing reaction: CO₂+O→CO+O₂,
   a carbon dioxide supply (20) configured for supplying carbon dioxide to be converted to the mixing area (M-A),
   a control device (30) configured for controlling a first supply rate of atomic oxygen (S_{O}) supplied to the mixing area and controlling a second supply rate of carbon dioxide (S_{CO2}) supplied to the mixing area such that:

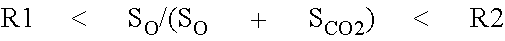

with S_{O} being said first supply rate of atomic oxygen, S_{CO2} said second supply rate of carbon dioxide, and wherein R1 and R2 are respectively a lower and an upper threshold, and
a gas outlet (43) configured for evacuating carbon monoxide from the mixing area (M-A).
26. The apparatus according to clause 25 comprising
   a user interface configured for inputting said upper and lower threshold,
   and/or
   a memory storing said upper and lower threshold.
27. The apparatus according to clause 25 or clause 26 wherein R1≥0.1 and R2≤0.9, preferably R1≥0.2 and R2≤0.8, more preferably R1≥0.3 and R2≤0.7.
28. The apparatus according to clause 25 wherein the control device (30) comprises a controller (33) and a computer program that when executed by the controller determines said lower (R1) and upper (R2) threshold for a required gas temperature (T_{m-req}) to be obtained in said mixing area (M-A), and wherein said determining is based on a pre-defined mathematical or tabular relation between a gas temperature (Tₘ) in said mixing area (M-A) and said ratio S_{O}/S_{CO2}, and wherein the apparatus comprises a user interface for entering the required gas temperature (T_{m-req}) for the mixing area and/or a memory for storing the required gas temperature (T_{m-req}) for the mixing area.
29. The apparatus according to clause 25 wherein said required gas temperature (T_{m-req}) is within a temperature range:
   500° K≤T_{m-req}≤3000° K, preferably 800° K≤T_{m-req}≤2500° K, more preferably 1000° K≤T_{m-req}≤2500° K,
with T_{m-req} being said required gas temperature in the mixing area (M-A), such that an occurrence of the first CO producing reaction:

CO₂+O→CO+O₂ with ΔH°=0.3 eV/molecule,
is larger than an occurrence of a second CO producing reaction:

CO₂+M→CO+O+M with ΔH°=5.5 eV/molecule,
with ΔH being the standard enthalpy for the reactions, and with M being any neutral molecule.
30. The apparatus according to any of clauses 25 to 27 comprising a heating and/or cooling device configured for heating and/or cooling said mixing area (M-A) so as to maintain a gas temperature (Tₘ) in the mixing area equal to an optimum temperature value (Tₘ₋ₒₚₜ) within a margin, and wherein said margin is maximum 15%, preferably maximum 10%, more preferably maximum 5%, such that:

$${T}_{m - opt} - ER \leq {T}_{m} \leq {T}_{m - opt} + ER ,$$

with Tₘ being the gas temperature in the mixing area and Tₘ₋ₒₚₜ being said pre-defined optimum gas temperature value and ER being said margin.
31. The apparatus according to any of clauses 25 to 28 wherein a dimension of said gas outlet (43) and/or a pump coupled to the gas outlet (43) is configured for maintaining a gas pressure (Pₘ) in said mixing area (M-A) within pressure limits such that
   10³ Pa≤Pₘ≤10⁶ Pa, preferably 10³ Pa≤Pₘ≤10⁵ Pa, more preferably 10⁴ Pa≤Pₘ≤10⁵ Pa, with Pₘ being the pressure within said mixing area (M-A).
32. The apparatus according to clause 31 wherein a volume of said mixing area (M-A) and said dimension of said gas outlet (43) and/or said pump are configured for allowing the atomic oxygen and the carbon dioxide molecules to interact within the mixing area during a minimum time period longer than 0.1 milliseconds, preferably longer than 0.5 milliseconds, more preferably longer than one millisecond.
33. The apparatus according to any of clauses 25 to 32 comprising a mixing chamber (40) elongating along a longitudinal axis (Z) and wherein said mixing chamber is delimiting said mixing area (M-A), and wherein said mixing chamber (40) comprises: a) an axial entrance (41) configured for receiving said atomic oxygen produced by said atomic oxygen generator (10), b) one or more inlet openings (41) configured for supplying the carbon dioxide to the mixing chamber (40), and c) an outlet opening for evacuating carbon monoxide from the mixing chamber and wherein said outlet opening corresponds to said gas outlet (43) of the apparatus.
34. The apparatus according to any of clauses 25 to 33 wherein said atomic oxygen generator (10) is configured for generating a stream of atomic oxygen flowing through the mixing area (M-A) in a first direction and wherein said carbon dioxide supply (20) is configured for injecting the carbon dioxide into said mixing area (M-A) in a second direction transversal to said first direction.
35. The apparatus according to any of clauses 25 to 34 wherein said atomic oxygen generator (10) is configured for converting molecular oxygen into atomic oxygen, and wherein said atomic oxygen generator comprises, an oxygen conversion area (12) wherein molecular oxygen is converted into atomic oxygen, and an oxygen supply (11) for supplying molecular oxygen to the oxygen conversion area (12).
36. The apparatus according to clause 35 wherein the control device (30) is configured for indirectly controlling said first supply rate of atomic oxygen (S_{O}) by controlling a third supply rate of molecular oxygen (S_{O2}) supplied through said oxygen supply (11).
37. The apparatus according to clause 35 or clause 36 wherein said control device (30) is configured for controlling said first supply rate of atomic oxygen by using a pre-defined relation between supplied molecular oxygen to the oxygen conversion area (12) and produced atomic oxygen in the oxygen conversion area (12).
38. The apparatus according to any of clauses 25 to 37 wherein said atomic oxygen generator (10) is a plasma generator configured for producing a plasma (101) comprising at least atomic oxygen and molecular oxygen, and wherein said oxygen conversion area (12) corresponds to a plasma area (PL-A) for forming the plasma (101).
39. The apparatus according to clause 38 wherein said mixing area (M-A) is located adjacently to said plasma area (PL-A) and configured such that when the plasma generator is in operation, atomic oxygen is flowing from the plasma area to the mixing area.
40. The apparatus according to clause 38 wherein said mixing area (M-A) is at least partly coinciding with said plasma area (PL-A).
41. The apparatus according to any of clauses 25 to 40 wherein the carbon dioxide supply (20) is configured for supplying the carbon dioxide to the mixing area (M-A) at a gas supply pressure (P_{CO2}) and a gas supply temperature (T_{CO2}), and wherein
   10³ Pa≤P_{CO2}≤10⁶ Pa, preferably 10³ Pa≤P_{CO2}≤10⁵ Pa, with P_{CO2} being said gas supply pressure,
   and 200° K≤T_{CO2}≤400° K, preferably 250° K≤T_{CO2}≤350° K, more preferably 270° K≤T_{CO2}≤320° K, with T_{CO2} being said gas supply temperature.
42. The apparatus according to any of clauses 25 to 41 wherein said first supply rate (S_{O}) and said second supply rate (S_{CO2}) correspond respectively to a number of oxygen atoms supplied per unit of time into the mixing area and a number of carbon dioxide molecules supplied per unit of time into the mixing area.
43. The apparatus according to clause 36 wherein said third supply rate (S_{O2}) corresponds to a number of oxygen molecules supplied per unit of time into the mixing area.
44. The apparatus according to any of clause 25 to 43 wherein said apparatus is suitable for performing the method according to any of clauses 1 to 22.

### REFERENCE NUMBERS

| | |
|---|---|
| 10 | atomic oxygen generator |
| 11 | O2 supply |
| 12 | O2 conversion area for transforming O2 into O |
| 15 | O2 reservoir |
| 20 | carbon dioxide supply |
| 30 | control device |
| 31 | O2 flow control valve |
| 32 | CO2 flow control valve |
| 33 | controller |
| 40 | Mixing chamber |
| 41 | Gas inlet opening for supplying CO2 |
| 42 | entrance for receiving O |
| 43 | Gas outlet for evacuating CO |
| 100 | apparatus |
| 101 | plasma |
| 102 | Wave guide |
| M-A | Mixing area |
| PL-A | Plasma area |
| Pₘ | Pressure in mixing area |
| P_{CO2} | Pressure of supplied CO2 |
| S_{O} | Supply rate of atomic oxygen |
| S_{CO2} | Supply rate of carbon dioxide |
| S_{O2} | Supply rate of oxygen molecules |
| Tₘ | Temperature in mixing area |
| T_{CO2} | Temperature of supplied CO2 |

1. A method for converting carbon dioxide into carbon monoxide comprising:
providing carbon dioxide to be converted,
producing atomic oxygen,
defining a first supply rate (S_{O}) of atomic oxygen and a second supply rate (S_{CO2}) of carbon dioxide such that: 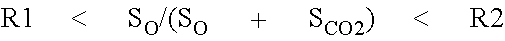
with S_{O} and S_{CO2} being respectively said first supply rate and said second supply rate, and wherein R1 and R2 are respectively a pre-defined lower and a pre-defined upper threshold,
mixing the carbon dioxide with the atomic oxygen within a mixing area (M-A) such that the atomic oxygen can interact with the carbon dioxide for forming carbon monoxide within the mixing area (M-A) through a first CO producing reaction: 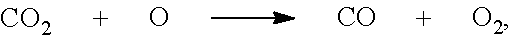
and supplying the atomic oxygen and carbon dioxide into the mixing area (M-A) at respectively said first supply rate (S_{O}) and said second supply rate (S_{CO2}),
evacuating carbon monoxide from the mixing area (M-A).

2. The method of claim 1 wherein R1≥0.1 and R2≤0.9.

3. The method according to claim 1 wherein heat is produced in the mixing area (M-A) through a recombination reaction:
O+O→O₂ and wherein ΔH°=−5.2 eV/molecule,
with ΔH° being a standard enthalpy for the recombination reaction, and wherein the method comprises:
obtaining a gas temperature (Tₘ) in said mixing area (M-A) that is comprised within a temperature range:
$${T}_{m - opt} - ER \leq {T}_{m} \leq {T}_{m - opt} + ER ,$$
with Tₘ being said gas temperature in the mixing area (M-A),
such that an occurrence of the first CO producing reaction:
CO₂+O→CO+O₂ with ΔH°=0.3 eV/molecule,
is larger than an occurrence of a second CO producing reaction:
CO₂+M→CO+O+M with ΔH°=5.5 eV/molecule,
with ΔH° being a standard enthalpy for the respective CO producing reactions, and with M being any neutral molecule.

4. The method according to claim 3 wherein said gas temperature (Tₘ) in the mixing area is obtained by controlling the first supply rate and the second supply rate such that said ratio between the first and second supply rate remains within the pre-defined lower and upper thresholds.

5. The method according to claim 3 comprising:
establishing a relation between the gas temperature (Tₘ) in the mixing area (M-A) and said ratio S_{O}/(S_{O}+S_{CO2}), and
defining said lower threshold R1 and said upper threshold R2 such that when controlling the ratio S_{O}/(S_{O}+S_{CO2}) within the lower and upper threshold, a gas temperature within said temperature range is obtained in the mixing area (M-A).

6. The method according to claim 1 comprising:
maintaining a gas temperature (Tₘ) in said mixing area (M-A) at a pre-defined optimum temperature value within a margin of maximum 15%:
$$500 ° K \leq {T}_{m} \leq 3000 ° K ,$$
with Tₘ being the gas temperature in the mixing area and Tₘ₋ₒₚₜ being said pre-defined optimum gas temperature value and ER being said margin,
and using a heating and/or cooling device for heating and/or cooling said mixing area (M-A) so as to maintain the gas temperature (Tₘ) in said mixing area (M-A) equal to the optimum temperature value within the margin.

7. The method according to claim 1 comprising:
maintaining a gas pressure (Pₘ) inside said mixing area (M-A) within pressure limits such that 10³ Pa≤Pₘ≤10⁶ Pa, with Pₘ being the pressure within said mixing area (M-A).

8. The method according to claim 1 comprising:
allowing the atomic oxygen and the carbon dioxide to interact within the mixing area (M-A) during a minimum time period longer than 0.1 milliseconds.

9. The method according to claim 1 wherein the atomic oxygen is supplied into the mixing area as a combination of atomic oxygen and molecular oxygen, and wherein the method comprises:
maintaining a ratio between the atomic oxygen supplied and the molecular oxygen supplied equal or larger than a minimum value:
S_{O}/S_{O2}≥0.10, with S_{O2} being a third supply rate of molecular oxygen.

10. An apparatus for converting carbon dioxide into carbon monoxide comprising:
an atomic oxygen generator for producing atomic oxygen,
a mixing area (M-A) configured for mixing the produced atomic oxygen with carbon dioxide to be converted such that when the apparatus is in operation, atomic oxygen can interact with the carbon dioxide within the mixing area (M-A) for forming carbon monoxide through a first CO producing reaction: CO₂+O→CO+O₂,
a carbon dioxide supply (20) configured for supplying carbon dioxide to be converted to the mixing area (M-A),
a control device (30) configured for controlling a first supply rate of atomic oxygen (S_{O}) supplied to the mixing area and controlling a second supply rate of carbon dioxide (S_{CO2}) supplied to the mixing area such that: 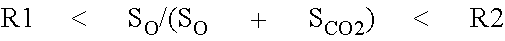
with S_{O} being said first supply rate of atomic oxygen, S_{CO2} said second supply rate of carbon dioxide, and wherein R1 and R2 are respectively a lower and an upper threshold, and
a gas outlet configured for evacuating carbon monoxide from the mixing area (M-A).

11. The apparatus according to claim 10 comprising a heating and/or cooling device configured for heating and/or cooling said mixing area (M-A) so as to maintain a gas temperature (Tₘ) in the mixing area equal to an optimum temperature value (Tₘ-opt) within a margin, and wherein said margin is maximum 15%, such that:
$${T}_{m - opt} - ER \leq {T}_{m} \leq {T}_{m - opt} + ER ,$$
with Tₘ being the gas temperature in the mixing area and Tₘ₋ₒₚₜ being said pre-defined optimum gas temperature value and ER being said margin.

12. The apparatus according to claim 10 wherein a dimension of said gas outlet and/or a pump coupled to the gas outlet is configured for maintaining a gas pressure (Pₘ) in said mixing area (M-A) within pressure limits such that 10³ Pa≤Pₘ≤10⁶ Pa, with Pₘ being the pressure within said mixing area (M-A).

13. The apparatus according to claim 12 wherein a volume of said mixing area (M-A) and said dimension of said gas outlet (43) and/or said pump are configured for allowing the atomic oxygen and the carbon dioxide molecules to interact within the mixing area during a minimum time period longer than 0.1 milliseconds.

14. The apparatus according to claim 10 wherein said atomic oxygen generator is configured for converting molecular oxygen into atomic oxygen, and wherein said atomic oxygen generator comprises, an oxygen conversion area wherein molecular oxygen is converted into atomic oxygen, and an oxygen supply for supplying molecular oxygen to the oxygen conversion area.

15. The apparatus according to claim 14 wherein said control device is configured for controlling said first supply rate of atomic oxygen by using a pre-defined relation between supplied molecular oxygen to the oxygen conversion area and produced atomic oxygen in the oxygen conversion area.
